(19) United States
(12) Patent Application Publication
(10) Pub. No.: US 2008/0282818 A1
(43) Pub. Date: Nov. 20, 2008

(54) Sensors with nanoparticles

(76) Inventors: Charles Smith, Encinitas, CA (US); Eduardo Jimenez, Tudela (ES); Marta Lacaba, Tudela (ES)

Correspondence Address: HELLER EHRMAN LLP, 4350 La Jolla Village Drive, 7th Floor, San Diego, CA, 92122, US

(21) Appl. No.: 11/749,925

(22) Filed: May 17, 2007

(51) Int. Cl. G01B 7/00; G01P 13/00

(52) U.S. Cl. 73/866.1; 977/953

(57) ABSTRACT

A sensor is provided with a base with at least one resistive track which includes a nano particle based conductive ink. A contact device makes contact along at least a portion of the resistive track and provides an indication of position or movement.

### BACKGROUND

1. Field of the Invention

This invention relates generally to sensors, and more particularly to sensors that are more wear resistant.

2. Description of the Related Art

Position sensing is used to monitor the position or movement of a mechanical component. The position sensor produces a signal that varies as the position of the component in question varies. By way of illustration, position sensors allow the status of various automotive actuations and processes to be monitored and controlled electronically.

A position sensor must be accurate, in that it must give an appropriate signal based upon the position measured. If inaccurate, a position sensor will hinder the proper evaluation and control of the position of the component being monitored. A position sensor must also be adequately precise in its measurement. The precision needed in measuring a position will obviously vary depending upon the particular circumstances of use. For some purposes only a rough indication of position is necessary. For instance, an indication of whether a valve is mostly open or mostly closed. In other applications more precise indication of position may be needed.

A position sensor must also be sufficiently durable for the environment in which it is placed. For example, a position sensor used on an automotive valve will experience almost constant movement while the automobile is in operation. Such a position sensor must be constructed of mechanical and electrical components which are assembled in such a manner as to allow it to remain sufficiently accurate and precise during its projected lifetime, despite considerable mechanical vibrations and thermal extremes and gradients.

Contact position sensors require physical contact between a signal generator and a sensing element to produce the signal. Contacting position sensors typically consist of a potentiometer to produce electrical signals that vary as a function of the component's position. Contacting position sensors are generally accurate and precise. Unfortunately, the wear due to contact during movement of contacting position sensors has limited their durability. Also, the friction resulting from the contact can result in the sensor affecting the operation of the component. Further, water intrusion into a potentiometric sensor can disable the sensor.

There is a need for an improved position sensor that has reduced wear. There is a further need for an improved position sensor that has an increased lifetime. Yet there is a further need for an improved position sensor with longer life, and consistent and reliable performance in demanding industrial applications and environmental conditions.

### SUMMARY

Accordingly, an object of the present invention is to provide an improved position sensor.

Another object of the present invention is to provide an improved position sensor that has an increased lifetime.

A further object of the present invention is to provide an improved position sensor with longer life, and consistent and reliable performance in demanding industrial applications and environmental conditions.

Yet another object of the present invention is to provide an improved position sensor that improves the wear resistance of the resistive track and the contact device.

These and other objects of the present invention are achieved in a sensor that has a base with at least one resistive track which includes a nano particle based conductive ink. A contact device makes contact along at least a portion of the resistive track and provides an indication of position or movement.

### BRIEF DESCRIPTION OF THE DRAWINGS

FIGS. 1 and 2 illustrates one embodiment of a sensor of the present invention that has a nano particle based conductive ink.

FIG. 3 illustrates the contact device with the device of FIGS. 1 and 2.

FIG. 4 illustrates electronics with the device of FIG. 3.

FIG. 5 illustrates the device of FIG. 3 with a collector, second resistive track, a second collector, a third resistive track and a third collector.

FIG. 6 illustrates distributed nano tubes in the resistive tract.

FIG. 7 illustrates an embodiment of FIG. 3 with the inclusion of a backing bar.

FIG. 8 illustrates the base of FIG. 3 with first and second resistive tracts.

### DETAILED DESCRIPTION

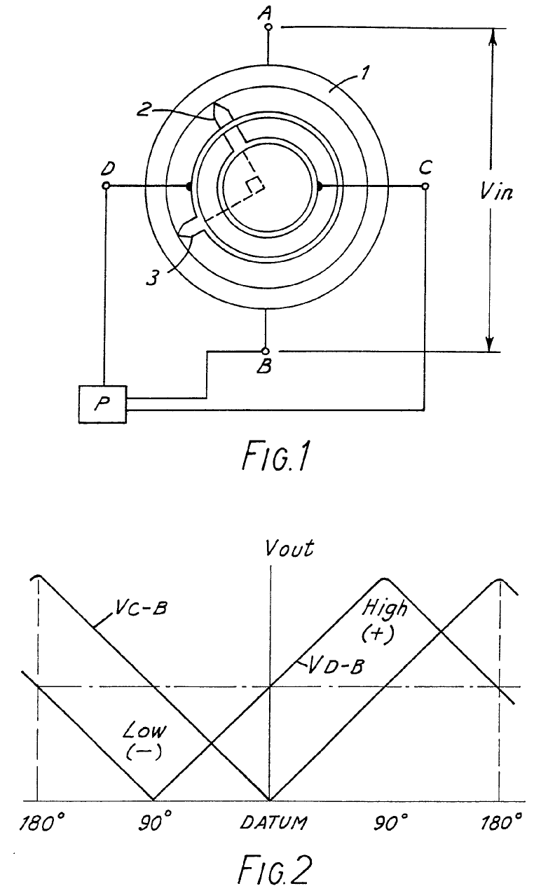

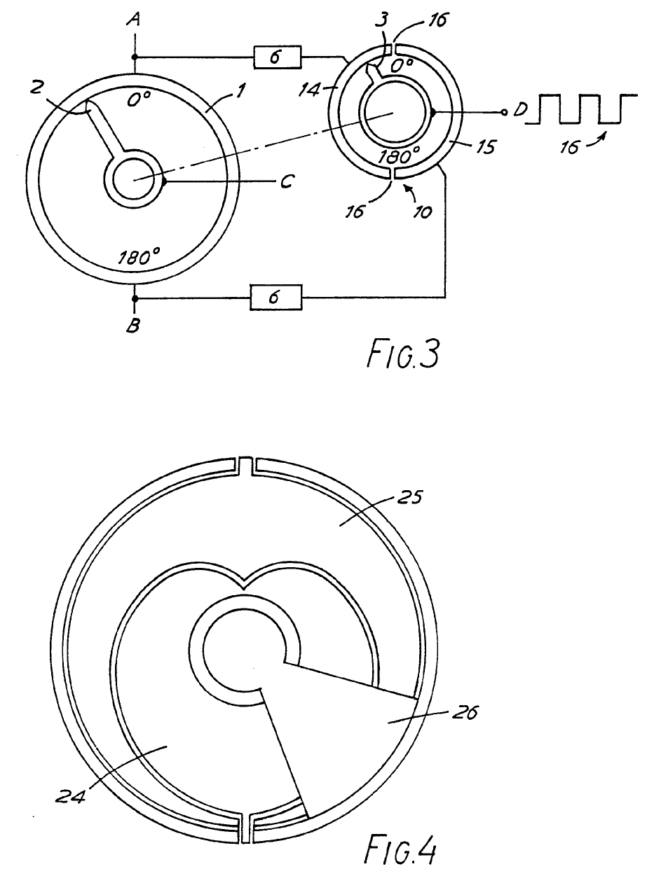

In one embodiment of the present invention, as illustrated in FIGS. 1 and 2, a sensor 10 is provided that has a base 12 with at least one resistive track 14 that includes a nano particle based conductive ink 16. As shown in FIG. 3, a contact device 18 is also included. The contact device 18 makes contact along at least a portion of the resistive track 14 and provides an indication of position or movement. The contact device 18 can be a single or multi-fingered wiper.

The resistive track 14 increases the robustness of the sensor 10 and makes it is less dependent on wear of the contact device 18 on the resistive track 14. The nano particle based conductive ink 16 improves wear resistance of the resistive track 14 and the contact device 18.

In various embodiments, the sensor 10 can be, a rotary sensor, a linear sensor and the like. In one embodiment, the sensor 10 detects motion or movement at any angle above 0 degrees and can have multiple turns. The sensor 10 can be used to detect motion or movement, and can be used in a variety of different applications including but not limited to, land vehicle, marine, industrial, aerospace, agricultural applications and the like.

The contact device 18 can include a nano-film 20 or can be a nano-film. In various embodiments, the contact device 18 makes a single contact or multiple point contacts with the resistive track 14.

Referring now to FIG. 4, electronics 22 can be coupled to the sensor 10 to create a transducer. As shown in FIG. 4, the sensor 10 can further include one or more of, a first collector 24, a second resistive track 26, a second collector 28, a third resistive track 30, a third collector 32 and the like.

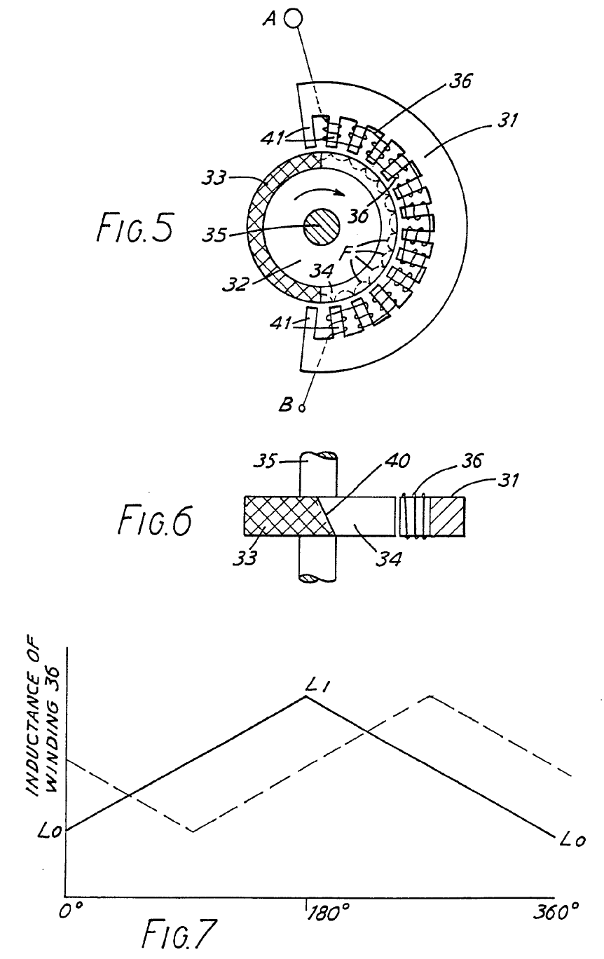

Referring not to FIG. 6, the resistive tract 14 can include distributed nano tubes 34 in the nano particle based conductive ink 16. The distributed nano tubes 34 can have a distribution selected to provide uniform resistance along the nano particle based conductive ink 16. The distributed nano tubes 34 can have a distribution selected to provide non-uniform resistance along the nano particle based conductive ink. 16

In one embodiment, the nano tubes are 34, single-walled nano tubes (SWNTs), double-walled nano tubes (DWNTs), multi-walled nano tubes (MWNTs), and mixtures thereof.

As illustrated in FIG. 7, in one embodiment the base 18 includes a backing bar 36, and the wiper slides between the backing bar 36 and the resistive track 14. The base can have first and second resistive tracks 14 and 38. The base 18 can have top and bottom resistive tracts 14 and 38, with the contact device 18 positionable between the top and bottom resistive tracks 14 and 38.

The resistive tracks 14 and 38 can contain carbon. In one embodiment, the resistive track includes at least one of a, metal, organic, ceramic, metal oxide, metal nitride, metal-organic, metal carbides and the like. The metal oxides can be, tin-indium mixed oxide (ITO), antimony-tin mixed oxide (ATO), fluorine-doped tin oxide (FTO) or aluminum-doped zinc oxide (FZO), zirconium, aluminum, cobalt, yttrium, vanadium and/or cadmium oxides. The metal nitrides can be titanium, boron and the like. The metal carbides can be, wolfram, tantalum, titanium and the like.

Other embodiments of the invention will be apparent to those skilled in the art from consideration of the specification and practice of the invention disclosed herein. It is intended that the specification and examples be considered as exemplary only, with a true scope and spirit of the invention being indicated by the appended claims.

What is claimed is:

1. A sensor, comprising:
a base with at least one resistive track that includes a nano particle based conductive ink; and
a contact device configured to make contact along at least a portion of the resistive track and provide an indication of position or movement.

2. The sensor of claim 1, wherein the contact device includes a nano-film.

3. The sensor of claim 1, wherein the contact device is a nano-film.

4. The sensor of claim 1, wherein the contact device makes a single contact point contact with the resistive track.

5. The sensor of claim 1, wherein the contact device makes multiple contact point contacts with the resistive track.

6. The sensor of claim 1, wherein the resistive track is configured to increase a robustness of the sensor and provide that the sensor is less dependent on wear of the contact device on the resistive track.

7. The sensor of claim 1, wherein the nano particle based conductive improves wear resistance of the resistive track and the contact device.

8. The sensor of claim 1, wherein the contact device is a wiper.

9. The sensor of claim 1, wherein the contact device is a multi-fingered wiper.

10. The sensor of claim 1, further comprising:
electronics coupled to the sensor to provide a transducer.

11. The sensor of claim 10, further comprising:
a first collector.

12. The sensor of claim 11, further comprising:
a second resistive track.

13. The sensor of claim 12, further comprising:
a second collector.

14. The sensor of claim 13, further comprising:
a third resistive track.

15. The sensor of claim 14, further comprising:
a third collector.

16. The sensor of claim 1, wherein the resistive tract includes distributed nano tubes in the nano particle based conductive ink.

17. The sensor of claim 16, wherein the distributed nano tubes have a distribution selected to provide uniform resistance along the nano particle based conductive ink.

18. The sensor of claim 16, wherein the distributed nano tubes have a distribution selected to provide non-uniform resistance along the nano particle based conductive ink.

19. The sensor of claim 1, wherein the base includes a backing bar, and the wiper slides between the backing bar and the resistive track.

20. The sensor of claim 1, wherein the base includes first and second resistive tracks.

21. The sensor of claim 1, wherein the base includes top and bottom resistive tracts with the contact device positionable between the top and bottom resistive tracks.

22. The sensor of claim 1, wherein the sensor is a rotary sensor.

23. The sensor of claim 1, wherein the sensor is a linear sensor.

24. The sensor of claim 1, wherein the sensor is configured to detect motion or movement at any angle above 0 degrees and can have multiple turns.

25. The sensor of claim 1, wherein the sensor is configured to detect motion or movement

26. The sensor of claim 22, wherein the sensor is configured for use in land vehicle, marine, industrial, aerospace, and agricultural applications.

27. The sensor of claim 1, wherein the resistive tracks contains carbon.

28. The sensor of claim 1, wherein the resistive track includes at least one of a metal, organic, ceramic, metal oxide, metal nitride and metal-organic.

29. The sensor of claim 28, wherein the metal oxides are selected from tin-indium mixed oxide (ITO), antimony-tin mixed oxide (ATO), fluorine-doped tin oxide (FTO) or aluminum-doped zinc oxide (FZO), zirconium, aluminum, cobalt, yttrium, vanadium and/or cadmium oxides.

30. The sensor of claim 28, wherein the metal nitrides are selected from titanium or boron.

31. The sensor of claim 28, wherein the metal carbides are selected from wolfram, tantalum and/or titanium.

32. The sensor of claim 31, wherein the nano tubes are selected from the group consisting of single-walled nano tubes (SWNTs), double-walled nano tubes (DWNTs), multi-walled nano tubes (MWNTs), and mixtures thereof.

33. The sensor of claim 32, wherein the nano tubes are substantially single-walled nano tubes (SWNTs).

34. The sensor of claim 32, wherein the nano tubes are substantially multi-walled nano tubes (MWNTs).
